(19) United States
(12) Patent Application Publication
(10) Pub. No.: US 2009/0209379 A1
(43) Pub. Date: Aug. 20, 2009

(54) LATHE BELT TENSION DESIGNS

(75) Inventors: James P. Nichols, JR., Jackson, TN (US); Carl F. Merhar, III, Jackson, TN (US); Sarah J. Grenier, Jackson, TN (US); Zackary N. Jackson, Jackson, TN (US); Timothy Wynne Preusch, Jackson, TN (US); Joseph Ghering, Jackson, TN (US)

Correspondence Address: HARNESS, DICKEY & PIERCE, P.L.C., P.O. BOX 828, BLOOMFIELD HILLS, MI, 48303, US

(73) Assignee: BLACK & DECKER INC., Newark, DE (US)

(21) Appl. No.: 12/033,380

(22) Filed: Feb. 19, 2008

(51) Int. Cl. F16H 7/10

(52) U.S. Cl. 474/112

(57) ABSTRACT

A belt tensioning device is provided for an apparatus such as a lathe which includes a centering member adapted to be attached to a workpiece and is supported for rotation about an axis. A motor is spaced from the centering member and is supported by a pivot member. A drive pulley is attached to the motor and a driven pulley is attached to the centering member. A belt is engaged between the drive pulley and the driven pulley for transmitting driving torque from the motor to the centering member. A belt tensioning device is provided for moving the pivot member between a first position wherein the belt is tensioned between the drive and driven pulleys and a second position wherein the belt is loosened between the drive and driven pulleys.

### FIELD

The present disclosure relates to woodworking lathes and more particularly, to belt tensioning designs for a lathe.

### BACKGROUND

The statements in this section merely provide background information related to the present disclosure and may not constitute prior art.

A lathe is a woodworking tool which spins a block of wood or other material to perform various operations such as cutting, sanding, knurling or deformation with tools that are applied to a workpiece to create an object which has symmetry about an axis of rotation. The material is held in place by either one or two centers, at least one of which can be moved horizontally to accommodate varying material lengths. Various types of spindles, cue sticks, table legs and baseball bats are examples of objects that can be produced on a lathe.

In current lathe designs, an electric motor or other source of rotary power includes a drive pulley which is connected to a drive belt which drives a driven pulley that is connected to the workpiece for turning the workpiece about a central axis. In a typical lathe, the user manually tensions the drive belt and clamps it in place so that the belt is provided with sufficient tension so as not to slip on the drive or driven pulleys. Although this prior belt tensioning technique is satisfactory for its intended purpose, improvements to the belt tensioning design can simplify the technique and/or prevent the necessity for repeated belt tensioning as the belt is stretched or worn through use.

### SUMMARY

A belt tensioning device is provided for a device such as a lathe including a centering member adapted to be attached to a workpiece and being supported for rotation about an axis. A motor is spaced from the centering member and supported by a pivot member. A drive pulley is attached to the motor and a driven pulley is attached to the centering member. A belt is engaged between the drive pulley and the driven pulley for transmitting driving torque from the motor to the centering member. A device is provided for moving the pivot member between a first position wherein the belt is tensioned between the drive and driven pulleys and a second position wherein the belt is loosened between the drive and driven pulleys. A locking device is operable to retain the pivot member in the loosened position. The belt tensioning device can be used with other power tools such as a drill press and other power tools that use a belt drive.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of a prior art lathe utilizing a known belt tensioning;

FIG. 2 is a perspective view of a belt tensioning device according to the principles of the present disclosure;

FIG. 3A is an end view of the belt tensioning device shown in FIG. 2, with the belt in a tensioned condition;

FIG. 3B is a schematic view of the belt tensioning device shown in FIG. 2, with the belt loosened;

FIG. 3C is a perspective view of latching mechanism for holding the belt tensioning device in a loosened condition;

FIG. 4 is a perspective view of an alternative belt tensioning device in accordance with the principles of the present disclosure;

FIG. 5 is a side schematic view of the belt tensioning device shown in FIG. 4;

FIG. 6 is a front plan view of the belt tensioning device shown in FIG. 4;

FIG. 7A is a perspective view of an alternative belt tensioning device according to the principles of the present disclosure;

FIG. 7B shows a perspective view of the pull knob device of FIG. 7A shown in an unlocked postion;

FIG. 7C shows a perspective view of the belt tensioning device of FIG. 7 with the belt shown in a loosened condition;

FIG. 7D shows a perspective view of the pull knob device of FIG. 7A shown in a locked postion;

FIG. 7E is an exploded perspective view of the belt tensioning device shown in FIG. 7A;

FIG. 8 is a schematic view of the belt tensioning device shown in FIG. 7;

FIG. 9 is a perspective view of still another belt tensioning device according to the principles of the present disclosure;

FIG. 10 is a schematic view of the belt tensioning device shown in FIG. 9;

FIG. 11 is a schematic view of a belt tensioning device according to still another embodiment of the present disclosure;

FIG. 12 is a side view of the belt tensioning device shown in FIG. 11.

### DETAILED DESCRIPTION

The following description is merely exemplary in nature and is not intended to limit the present disclosure, application, or uses. It should be understood that throughout the drawings, corresponding reference numerals indicate like or corresponding parts and features.

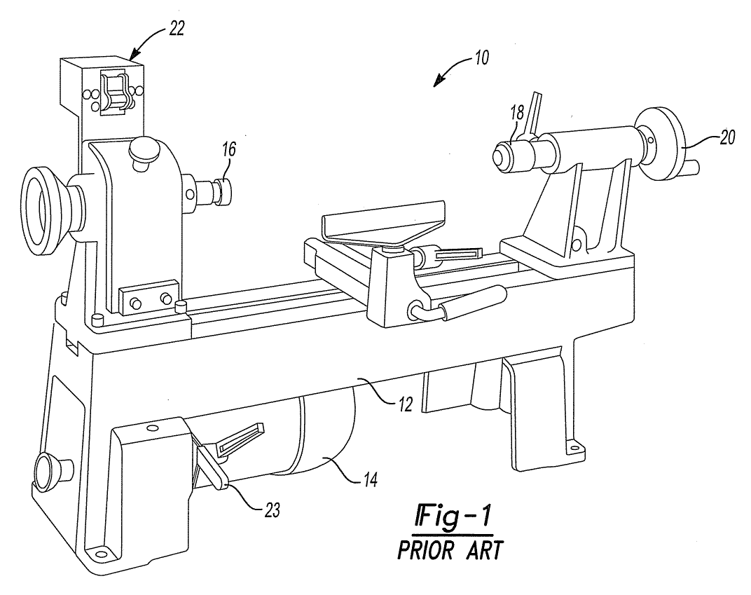

With reference to FIG. 1, a lathe 10 is shown. The lathe 10 is a woodworking tool which spins a block of wood or other material to perform various operations such as cutting, sanding, knurling or deformation with tools that are applied to the workpiece to create an object which has symmetry about an axis of rotation. The lathe 10 includes a base structure 12 which supports a motor 14 which is drivingly connected to a first center member 16 as will be described herein. A workpiece is supported between the first center member 16 and a second center member 18 which can be moved horizontally relative to the support structure 12 in order to accommodate varying material lengths of the workpiece. As is known in the art, horizontal movement of the second centering member 18 can be accomplished by rotary dial 20 or by other adjustment mechanisms as are known in the art. As shown in FIG. 1, an on/off switch 22 can be provided on the lathe 10 for operating the motor 14 to drive the workpiece.

In a typical lathe, and in other power tools, the motor is provided with a drive pulley which drives a belt which engages a driven pulley which drives the first center member 16. The motor is attached to a pivoting plate 23 which includes a handle or other grasping provision and can be held in various positions by a clamping device. The user releases the clamp and manually raises or lowers the pivoting plate 23 to release or apply tension to the drive belt and clamps it in the desired position.

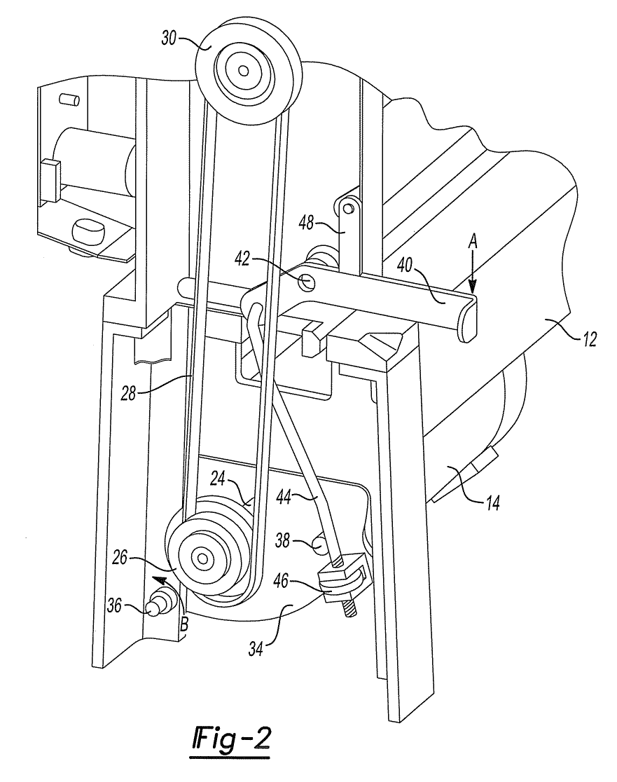

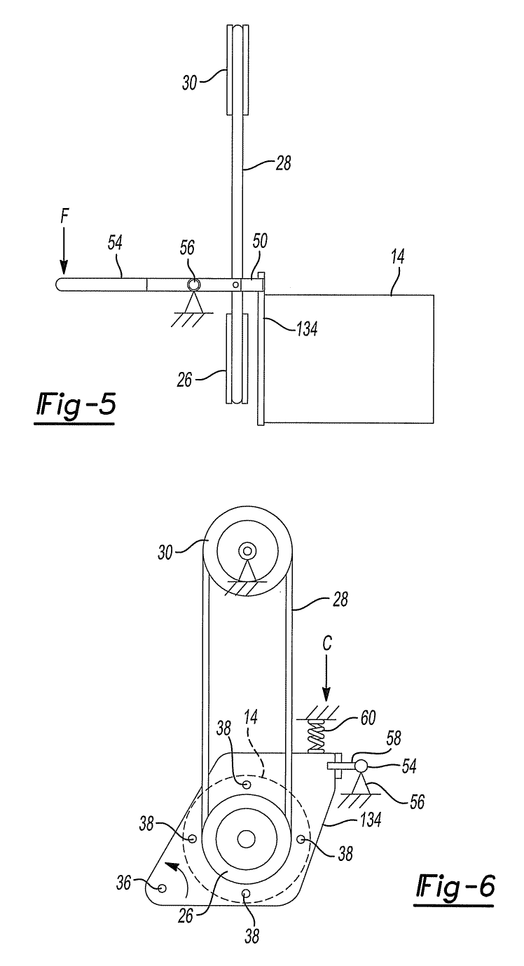

The present disclosure is directed to several belt tensioning devices and release mechanisms for a lathe or other power tools devices (for example, drill press) utilizing a drive belt. In each of the disclosed belt tensioning devices (FIGS. 2-11), a motor 14 is provided with a driveshaft 24 connected to a drive pulley 26 that drives a belt 28 that is connected to a driven pulley 30 that is connected to the center member 16 for turning the workpiece.

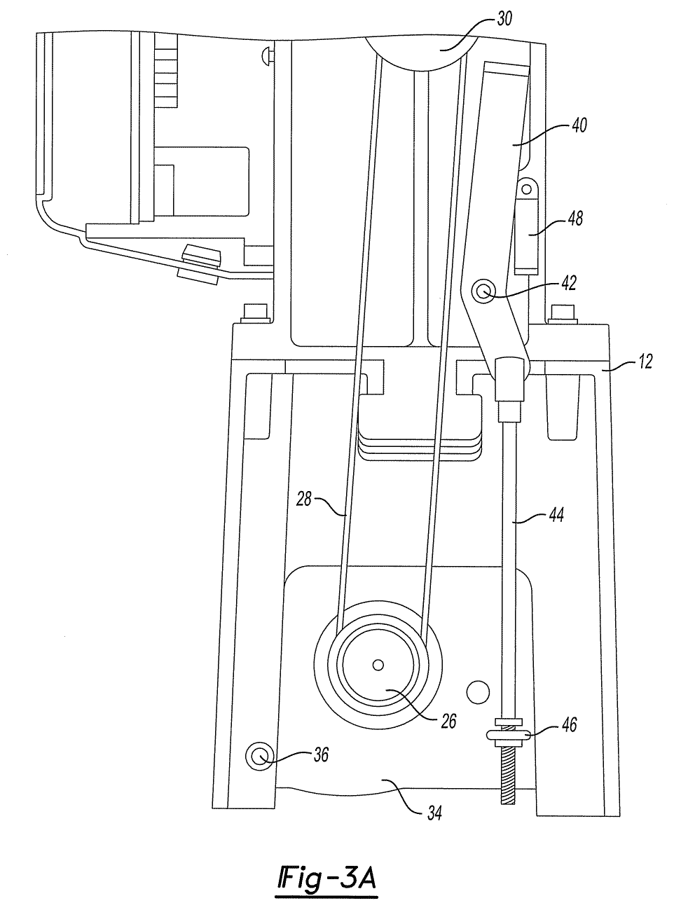

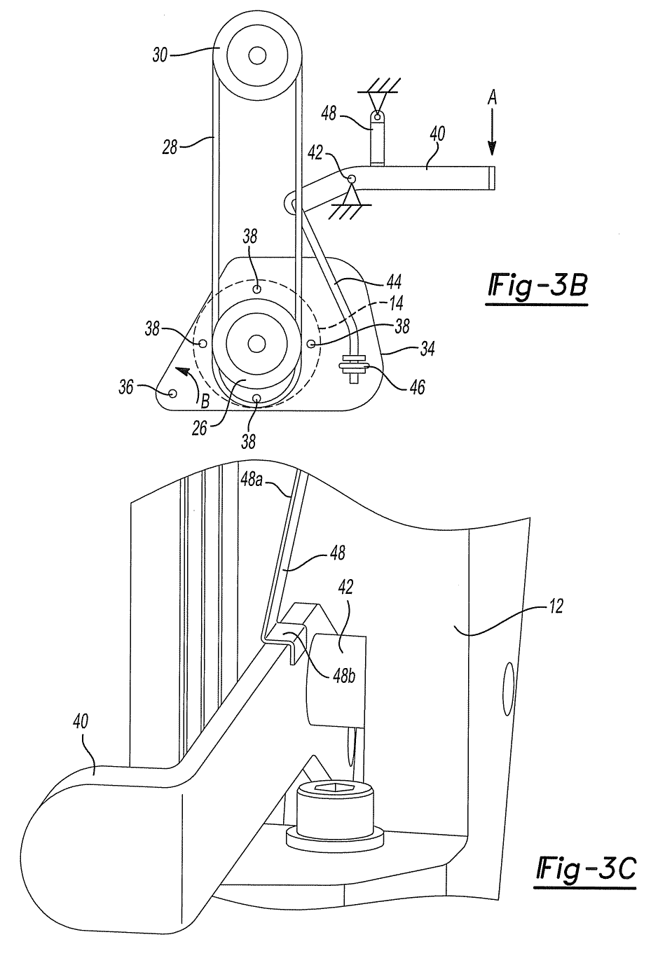

With particular reference to FIGS. 2 and 3A-3C, a belt tensioning device includes a pivot member in the form of a mounting plate 34 that can be pivotally mounted to a pivot point 36 which can be mounted to the support structure 12 of the lathe 10. The motor 14 can be mounted to the pivot member 34 such as by fasteners 38 or, alternatively, the pivot member can be integral to the motor 14. A lever arm 40 can be pivotally mounted to the support structure 12 of the lathe 10 by a pivot point 42. The lever arm 40 can be connected to the pivot member 34 by a link 44, or alternatively, by a linkage system, direct connection or other known connection device. The lever arm 40 and link 44 can be constructed or arranged such that when the lever arm 40 is pivoted to apply tension to the belt 28, it rotates past a dead-center position as shown in FIG. 3A, and comes to rest against a stopping feature either affixed or integral to the support structure 12, thereby locking into place. An adjustment can be provided to the link 44, such as a threaded portion of the link 44 in conjunction with a thumb wheel nut 46, so as to allow the length of the link 44 to be varied, thereby increasing or decreasing the amount of tension applied to the belt 28 when the lever arm 40 is in the locked position. The user can release the tension on the belt 28 by rotating the lever arm 40 past the dead-center locking position and pressing downward as illustrated by arrow A, wherein the pivot member 34 is rotated in the direction of arrow B which causes the drive pulley 26 to move in an upward direction toward the fixed driven pulley 30 in order to release the tension on the belt 28 to allow the belt 28 to be re-positioned or replaced as necessary. A latching device, such as a locking tab 48, can be provided for engaging the lever arm in the tension released position so that the operator has two hands free to adjust or change the belt. As shown in FIG. 3C, the locking tab 48 can be a spring arm that has a cam surface 48a that pushes the tab 48 inward as the lever arm 40 is pivoted to the tension release position illustrated in FIGS. 2, 3B and 3C. The tab 48 includes a locking finger 48B that engages the lever arm 40.

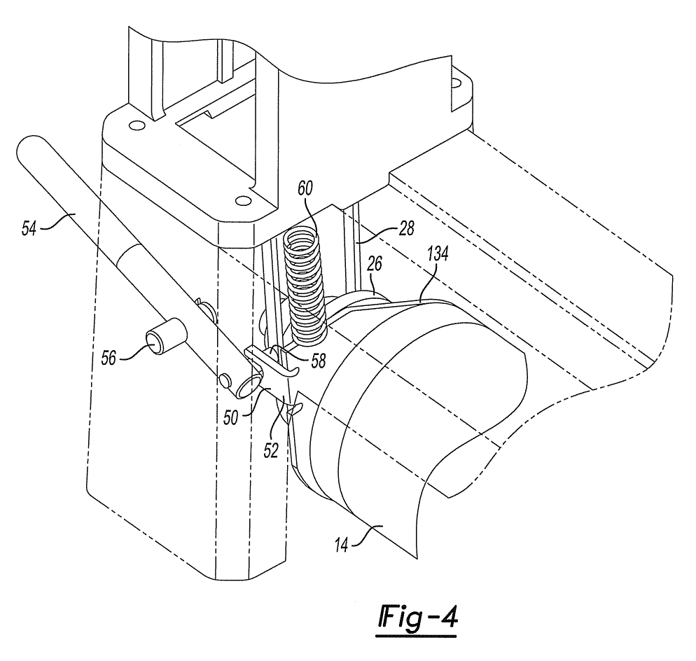

With reference to FIGS. 4-6, an alternative belt tensioning device according to the principles of the present disclosure will now be described. In the belt tensioning device as illustrated in FIGS. 4-6, the motor 14 is mounted to a pivot member 134 such as a motor mounting plate. The pivot member 134 is pivotally mounted to a pivot point 36 which can be mounted to the support structure 12 of the lathe 10. The pivot member 134 includes an elongated slot 50 that can be provided on an ear 52 extending from the pivot member 134. A lever arm 54 can be pivotally mounted to the support structure 12 at pivot point 56 and can include an engagement pin 58 which is received in the elongated slot 50 of the pivot member 134. A spring 60 can be disposed between the pivot member 134 and the support structure 12 to provide a downward force against the pivot member 134 as illustrated by arrow C as shown in FIG. 6. The spring 60 applies a downward force on the pivot member 134 which provides additional tension on the belt 28. In addition, the weight of the motor 14 also provides tension on the belt 28 to prevent slippage thereof. The operator can press downward on the lever arm 54 in order to cause the lever arm 54 to pivot about pivot point 56 causing the pin member 58 to lift upward on the pivot member 134 causing the drive pulley 26 and motor 14 to lift upward toward the driven pulley 30 thus reducing the tension on the belt 28 to allow the belt 28 to be adjusted or replaced. A latch device can be provided to releasably secure the lever arm in the tension release position, freeing up both hands of the operator to adjust or change the belt 28.

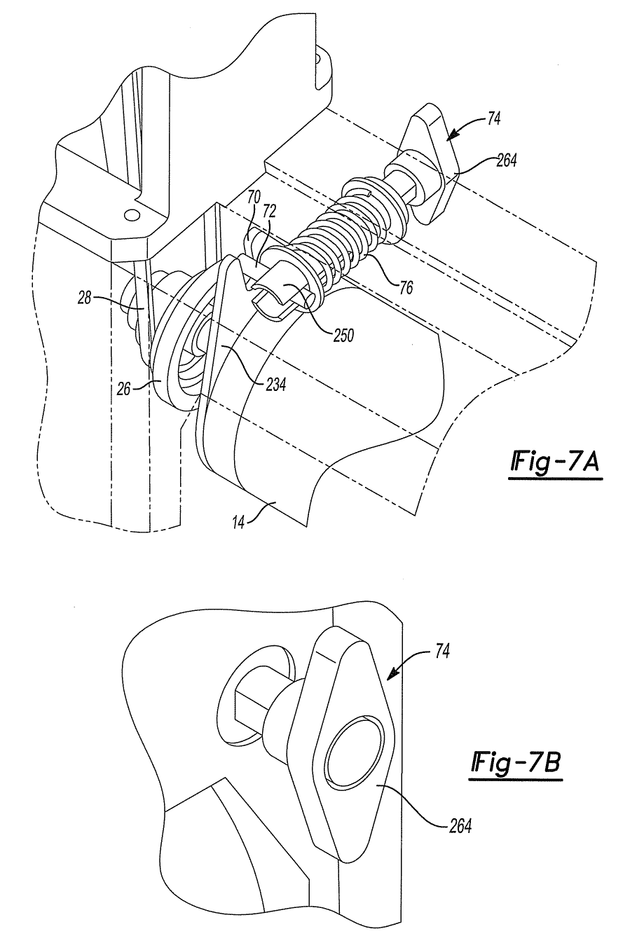

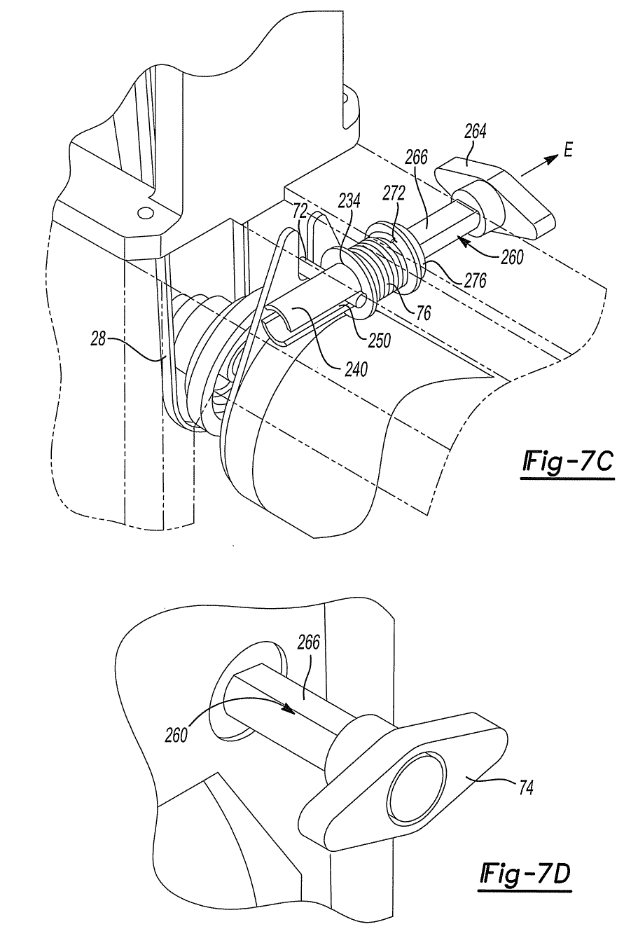

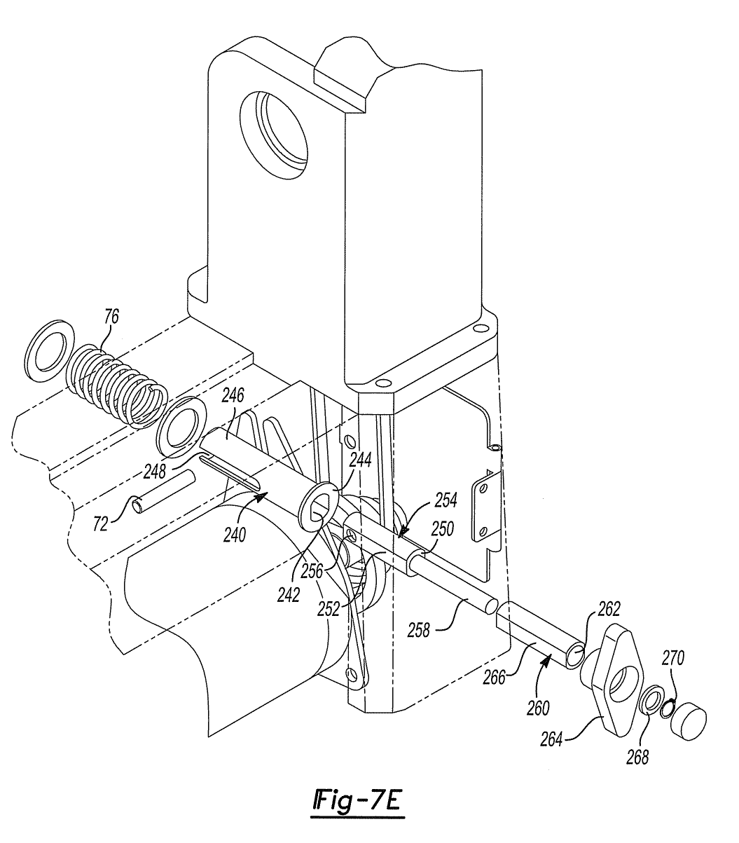

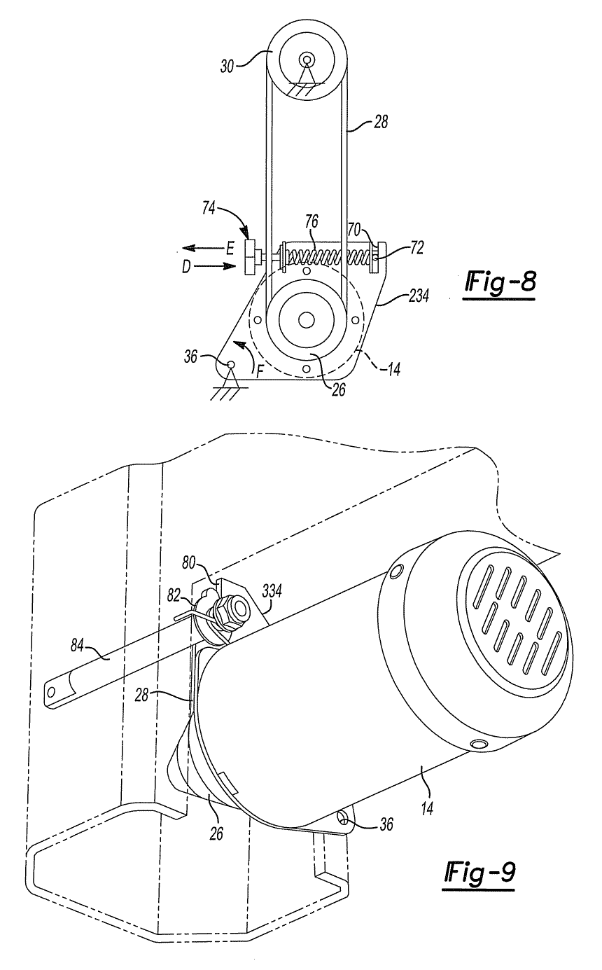

With reference to FIGS. 7 and 8, a still further belt tensioning device will now be described. With particular reference to FIG. 8, the device includes a pivot member 234 that can be mounted to the support structure 12 of the lathe 10 at pivot point 36. The pivot member 234 can include an elongated slot 70 that is disposed on an opposite side of the motor 14 from the pivot point 36. The slot 70 is engaged by a pin 72 which is attached to a pull knob device 74. The pull knob device 74 is provided with a bias spring 76 which biases the pull knob 74 in the direction of arrow D (FIG. 8). When the pull knob device 74 is pulled against the biasing force of the spring 76, in the direction of the arrow E (FIGS. 7C and 8), the drive pin 72 pulls against the pivot member 234, causing the pivot member 234 to rotate in the direction of arrow F causing the motor 14 and drive pulley 26 to move in an upward direction toward driven pulley 30 thus reducing the tension on belt 28. The spring 76 as well as the motor 14 apply forces to the pivot member 234 causing the pivot member 234 to rotate in a direction opposite to arrow F thus causing tension to be applied to belt 28. The pull knob 74 can be provided with a latch device for engaging the pull knob 74 in the tension release position so that the operator has two hands free to adjust or change the belt.

With reference to FIG. 7E, the pull knob device 74 includes a guide sleeve 240 having an aperture 242 extending therethrough. The aperture 242 includes at least one flat wall portion 244. An end 246 of the guide sleeve is provided with a pair of elongated slots 248. A pin rod 250 is received in the aperture 242 of the guide sleeve 240 and includes at least one slide portion 252 having at least one flat wall 254 to engage the at least one flat wall portion 244 of the guide sleeve 240 to prevent relative rotation therebetween. The pin rod 250 has a transverse aperture 256 for fixedly supporting drive pin 72 therein. The pin rod 250 also includes a cylindrical rod portion 258 extending form the slide portion 252. A handle shaft 260 is provided with a circular aperture 262 for receiving the cylindrical rod portion 258 therein. The handle shaft 260 is non-rotatably fixed to a handle 264 and includes at least one flat wall 266, similar to the slide portion 252. A washer 268 and retaining clip 270 secure the handle shaft 260 rotatably on the pin rod 250. In the assembled condition as illustrated in FIG. 7C, a pair of washers 272, 274 retain the spring 76 on the guide sleeve 240 between an end flange 276 of the guide sleeve 240 and the drive pin 72 which is received in the pin rod 250. When the hand 264 is pulled to the position shown in FIG. 7C, the handle shaft 260 is fully removed from the aperture 242 of the guide sleeve 240 and is therefore free to rotate relative to the guidesleeve. By rotating the handle 264 and handle shaft to the position shown in FIGS. 7C, 7D, the flat 266 on the handle shaft is misaligned with the flat wall portion 244 and the handle shaft is not permitted to return to the position shown in FIGS. 7A and 7B until the handleshaft is rotated so that the flat 266 aligns with the flat wall portion 244. Thus, the user is free to use both hands to adjust or change the belt 28.

With reference to FIGS. 9 and 10, a still further belt tensioning device will now be described. The belt tensioning device includes a pivot member 334 to which the motor 14 is mounted. The pivot member 334 is mounted to a pivot point 36 which can be provided on the support structure 12 of the lathe 10. The pivot member 334 includes a cam follower surface 80 which rests against a cam member 82. The cam member 82 is supported by a shaft 84 which can be rotated to cause cam member 82 to lift upward on the cam follower surface 80 of the pivot member 334 thus causing the pivot member 334 to rotate in the direction of arrow G as illustrated in FIG. 10. When the pivot member 334 rotates in the direction of arrow G, the motor 14 and drive pulley 26 are moved in an upward direction toward driven pulley 30, thus reducing the tension on belt 28. With the tension on the belt 28 released, the belt 28 can be replaced or adjusted. A torsion spring 90 can be mounted to the shaft 84 which is connected to the cam member 82 and the torsion spring 90 can apply a downward force against the pivot member 334 or motor 14 apply a downward force tending to cause the pivot member 334 to rotate in a direction opposite arrow G and thus applying tension to the belt 28 along with the weight of the motor 14.

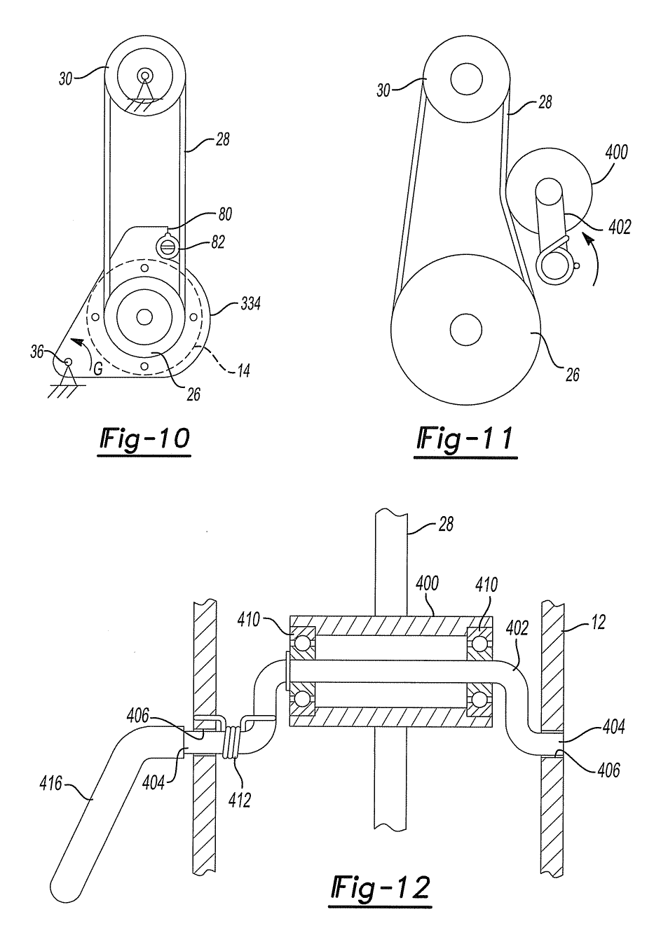

With reference to FIGS. 11 and 12, a still further belt tensioning device will now be described. With reference to FIG. 11, an idler pulley 400 is provided for applying tension to the belt 28. The idler pulley 400 is supported by a arm structure 402 which is pivotally mounted to the support structure 12 of lathe 10. The arm structure 402 can have a generally u-shape with opposite ears 404 which are received in apertures 406 provided in the support structure 12. The idler pulley 400 is supported on the arm 402 by bearing members 410. A torsion spring 412 can be provided for biasing the idler pulley 400 toward the belt 28 in order to tension the belt 28 between the drive pulley 26 and driven pulley 30. A handle 416 is connected to the arm member 402 to allow a user to pivot the arm member 402 so that the pulley 400 can be moved away from the belt 28 to reduce tension on the belt 28 to allow the belt to be either changed or adjusted.

What is claimed is:

1. A lathe, comprising:
a centering member adapted to be attached to a workpiece and being supported for rotation about an axis;
a motor spaced from said centering member and supported by a pivot member;
a first pulley attached to said motor;
a second pulley attached to said centering member;
a belt engaged between said first pulley and said second pulley for transmitting driving torque from said first pulley to said second pulley;
means for moving said pivot member between a first position wherein said belt is tensioned between said first and second pulleys and a second position, wherein said belt is loosened between said first and second pulleys; and
a spring device operable to bias said pivot member toward said first position.

2. The lathe according to claim 1, wherein said spring device acts directly against said pivot member.

3. The lathe according to claim 1, wherein said spring device acts directly on said means for moving said pivot member.

4. The lathe according to claim 1, wherein said pivot member includes a pivot plate mounted to said motor.

5. A lathe, comprising:
a centering member adapted to be attached to a workpiece and being supported for rotation about an axis;
a motor spaced from said centering member and supported by a pivot member;
a first pulley attached to said motor;
a second pulley attached to said centering member;
a belt engaged between said first pulley and said second pulley for transmitting driving torque from said first pulley to said second pulley; and
a pivot lever engaged with said pivot member for moving said pivot member between a first position wherein said belt is tensioned between said first and second pulleys and a second position, wherein said belt is loosened between said first and second pulleys.

6. The lathe according to claim 5, further comprising a linkage member connected between said pivot lever and said pivot member.

7. The lathe according to claim 5, wherein said pivot member includes a slot for receiving a portion of said pivot lever.

8. The lathe according to claim 5, wherein said pivot lever is rotatable past a dead center position for locking into place in a belt tensioned position.

9. The lathe according to claim 5, further comprising a locking tab adapted to hold said pivot lever in a tension released position.

10. The lathe according to claim 9, wherein said locking tab includes a spring arm.

11. The lathe according to claim 5, wherein said pivot member includes a pivot plate mounted to said motor.

12. A lathe, comprising:
a centering member adapted to be attached to a workpiece and being supported for rotation about an axis;
a motor spaced from said centering member and supported by a pivot member;
a first pulley attached to said motor;
a second pulley attached to said centering member;
a belt engaged between said first pulley and said second pulley for transmitting driving torque from said first pulley to said second pulley; and
a reciprocating handle member engaged with said pivot member for moving said pivot member between a first position wherein said belt is tensioned between said first and second pulleys and a second position, wherein said belt is loosened between said first and second pulleys.

13. The lathe according to claim 12, wherein said pivot member includes a slot for receiving a portion of said reciprocating handle member.

14. The lathe according to claim 12, further comprising a spring device operable to bias said pivot member toward said first position.

15. The lathe according to claim 14, wherein said spring device acts directly on said reciprocating handle member.

16. The lathe according to claim 15, wherein said reciprocating handle includes a handle shaft that is rotatable for securing said reciprocating handle member in said second position.

17. A lathe, comprising:
a centering member adapted to be attached to a workpiece and being supported for rotation about an axis;
a motor spaced from said centering member and supported by a pivot member;
a first pulley attached to said motor;
a second pulley attached to said centering member;
a belt engaged between said first pulley and said second pulley for transmitting driving torque from said first pulley to said second pulley; and
a cam member engaged with said pivot member for moving said pivot member between a first position wherein said belt is tensioned between said first and second pulleys and a second position, wherein said belt is loosened between said first and second pulleys.

18. The lathe according to claim 17, wherein said pivot member includes a surface for engaging said cam member.

19. The lathe according to claim 17, further comprising a spring device operable to bias said pivot member toward said first position.

20. The lathe according to claim 19, wherein said spring device acts directly on said pivot member.

21. The lathe according to claim 17, wherein said pivot member includes a pivot plate mounted to said motor.

22. A lathe, comprising:
a centering member adapted to be attached to a workpiece and being supported for rotation about an axis;
a motor spaced from said centering member and supported by a pivot member;
a first pulley attached to said motor;
a second pulley attached to said centering member;
a belt engaged between said first pulley and said second pulley for transmitting driving torque from said first pulley to said second pulley; and
an idler pulley disposed against said belt and movable between a first position wherein said belt is tensioned between said first and second pulleys and a second position, wherein said idler pulley disengages said belt and said belt is loosened between said first and second pulleys.

23. The lathe according to claim 22, further comprising a spring device operable to bias said idler pulley toward said first position.

24. The lathe according to claim 23, further comprising a handle operable to move said idler pulley to said second position.

25. A power tool, comprising:
a driven member supported for rotation about an axis;
a motor spaced from said driven member and supported by a pivot member;
a first pulley attached to said motor;
a second pulley attached to said driven member;
a belt engaged between said first pulley and said second pulley for transmitting driving torque from said first pulley to said second pulley;
means for moving said pivot member between a first position wherein said belt is tensioned between said first and second pulleys and a second position, wherein said belt is loosened between said first and second pulleys; and
a spring device operable to bias said pivot member toward said first position.

26. A power tool, comprising:
a driven member supported for rotation about an axis;
a motor spaced from said driven member and supported by a pivot member;
a first pulley attached to said motor;
a second pulley attached to said driven member;
a belt engaged between said first pulley and said second pulley for transmitting driving torque from said first pulley to said second pulley; and
a pivot lever engaged with said pivot member for moving said pivot member between a first position wherein said belt is tensioned between said first and second pulleys and a second position, wherein said belt is loosened between said first and second pulleys.

27. A power tool, comprising:
a driven member supported for rotation about an axis;
a motor spaced from said driven member and supported by a pivot member;
a first pulley attached to said motor;
a second pulley attached to said driven member;
a belt engaged between said first pulley and said second pulley for transmitting driving torque from said first pulley to said second pulley; and
a reciprocating handle member engaged with said pivot member for moving said pivot member between a first position wherein said belt is tensioned between said first and second pulleys and a second position, wherein said belt is loosened between said first and second pulleys.

28. A power tool, comprising:
a driven member supported for rotation about an axis;
a motor spaced from said driven member and supported by a pivot member;
a first pulley attached to said motor;
a second pulley attached to said driven member;
a belt engaged between said first pulley and said second pulley for transmitting driving torque from said first pulley to said second pulley; and
a cam member engaged with said pivot member for moving said pivot member between a first position wherein said belt is tensioned between said first and second pulleys and a second position, wherein said belt is loosened between said first and second pulleys.

29. A power tool, comprising:
a driven member supported for rotation about an axis;
a motor spaced from said driven member and supported by a pivot member;
a first pulley attached to said motor;
a second pulley attached to said driven member;
a belt engaged between said first pulley and said second pulley for transmitting driving torque from said first pulley to said second pulley; and
an idler pulley disposed against said belt and movable between a first position wherein said belt is tensioned between said first and second pulleys and a second position, wherein said idler pulley disengages said belt and said belt is loosened between said first and second pulleys.
